(19) United States
(12) Patent Application Publication
(10) Pub. No.: US 2008/0048043 A1
(43) Pub. Date: Feb. 28, 2008

(54) SEMICONDUCTOR MEMORY CARD

(75) Inventor: Taku NISHIYAMA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/842,619

(22) Filed: Aug. 21, 2007

(30) Foreign Application Priority Data
Aug. 23, 2006 (JP) 2006-226391

(51) Int. Cl. G06K 19/06

(52) U.S. Cl. 235/492

(57) ABSTRACT

A semiconductor memory card has a base card having an opening on the top thereof; a semiconductor package that incorporates a semiconductor memory having an input/output terminal that is formed on an upper surface thereof and that is electrically connected to the semiconductor memory and that can be connected to an external device, and being mounted in said base card in such a manner that the input/output terminal is exposed through said opening; and a mask plate that is mounted on the top of a side wall of said base card and covers said semiconductor package in such a manner that at least a part of said input/output terminal is exposed, wherein said base card and said mask plate are made of resin, at least one of said base card and said mask plate has a connecting part made of resin at a site where said base card and said mask plate are in contact with each other.

### CROSS-REFERENCE TO RELATED APPLICATION

This application is based upon and claims the benefit of priority from the prior Japanese Patent Application No. 2006-226391, filed on Aug. 23, 2006, the entire contents of which are incorporated herein by reference.

### BACKGROUND OF THE INVENTION

1. Field of the Invention

The present invention relates to a semiconductor memory card connected to an external device for use.

2. Background Art

Semiconductor memory cards incorporating a semiconductor memory chip are widely used as a data storage medium for digital devices, such as digital video cameras, cellular phones and portable music players. When writing or reading data to or from such a semiconductor memory card, the semiconductor memory card is inserted to a socket for the card on an external digital device and accesses the circuit in the digital device.

A conventional semiconductor memory card has a base card having an opening on the top thereof, a semiconductor package that incorporates a semiconductor memory for storing desired data, has an input/output terminal on the upper surface thereof that is electrically connected to the semiconductor memory and can be connected an external device for signal input/output, and is mounted in the base card in such a manner that the input/output terminal is exposed through the opening, and an adhesive label (a mask material) that is applied to the top surface of the base card and covers the semiconductor package in such a manner that at least a part of the input/output terminal is exposed (see Japanese Patent Laid-Open Publication No. 2003-346109).

### SUMMARY OF THE INVENTION

According one aspect of the present invention, there is provided: a semiconductor memory card comprising a base card having an opening on the top thereof; a semiconductor package that incorporates a semiconductor memory having an input/output terminal that is formed on an upper surface thereof and that is electrically connected to the semiconductor memory and that can be connected to an external device, and being mounted in said base card in such a manner that the input/output terminal is exposed through said opening; and a mask plate that is mounted on the top of a side wall of said base card and covers said semiconductor package in such a manner that at least a part of said input/output terminal is exposed, wherein said base card and said mask plate are made of resin, at least one of said base card and said mask plate has a connecting part made of resin at a site where said base card and said mask plate are in contact with each other.

### BRIEF DESCRIPTION OF THE DRAWINGS

FIG. 1 is a diagram showing a configuration of a semiconductor package of a semiconductor memory card according to an embodiment 1 of the present invention, which is an aspect of the present invention;

FIG. 2 is a diagram showing a configuration of a base card of the semiconductor memory card according to the embodiment 1 of the present invention, which is an aspect of the present invention;

FIG. 3 is a bottom view showing a configuration of a mask plate of the semiconductor memory card according to the embodiment 1 of the present invention, which is an aspect of the present invention;

FIG. 4 is a diagram showing a configuration of the semiconductor memory card according to the embodiment 1 of the present invention, which is an aspect of the present invention;

FIG. 5 is a cross-sectional view showing a configuration of the semiconductor memory card according to the embodiment 1 of the present invention, which is an aspect of the present invention;

FIG. 6 is a bottom view showing a configuration of another mask plate of the semiconductor memory card according to the embodiment 1 of the present invention, which is an aspect of the present invention;

FIG. 7 is a bottom view showing a configuration of still another mask plate of the semiconductor memory card according to the embodiment 1 of the present invention, which is an aspect of the present invention;

FIG. 8 is a diagram showing a configuration of a semiconductor memory card according to the embodiment 2 of the present invention, which is an aspect of the present invention;

FIG. 9 is a diagram showing a configuration of a semiconductor memory card according to the embodiment 3 of the present invention, which is an aspect of the present invention; and

FIG. 10 is a diagram showing a configuration of a semiconductor memory card according to the embodiment 4 of the present invention, which is an aspect of the present invention.

### DETAILED DESCRIPTION

In the following, embodiments of the present invention will be described with reference to the drawings, taking the SD card™ as an example of a semiconductor memory card can be connected to an external device for signal input and output. However, the present invention can equally be applied to other kinds of semiconductor memory cards.

### Embodiment 1

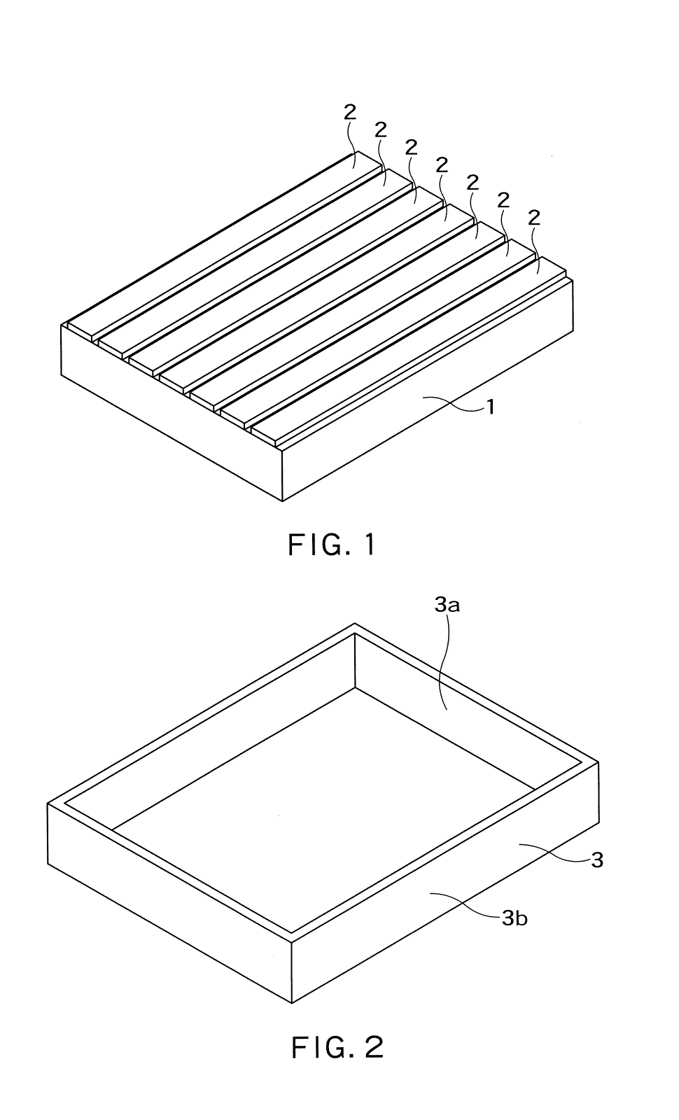

FIG. 1 is a diagram showing a configuration of a semiconductor package of a semiconductor memory card according to an embodiment 1 of the present invention, which is an aspect of the present invention.

As shown in FIG. 1, on the upper surface of a rectangular-plate-shaped semiconductor package 1 incorporating a semiconductor memory for storing desired data, an input/output terminal 2 that is electrically connected to the semiconductor memory and can be connected to an external device (not shown) for inputting and outputting signals.

The semiconductor memory incorporated in the semiconductor package 1 may be a nonvolatile memory, such as a NAND flash memory. The semiconductor package 1 further has a controller for controlling the semiconductor memory according to the signal input via the input/output terminal 2.

FIG. 2 is a diagram showing a configuration of a base card of the semiconductor memory card according to the embodiment 1 of the present invention, which is an aspect of the present invention.

As shown in FIG. 2, a rectangular base card 3 is made of a resin, such as polycarbonate. The base card 3 has an opening 3a on the top thereof, and the semiconductor package 1 is mounted in the base card 3 in such a manner that the input/output terminal 2 is exposed through the opening 3a.

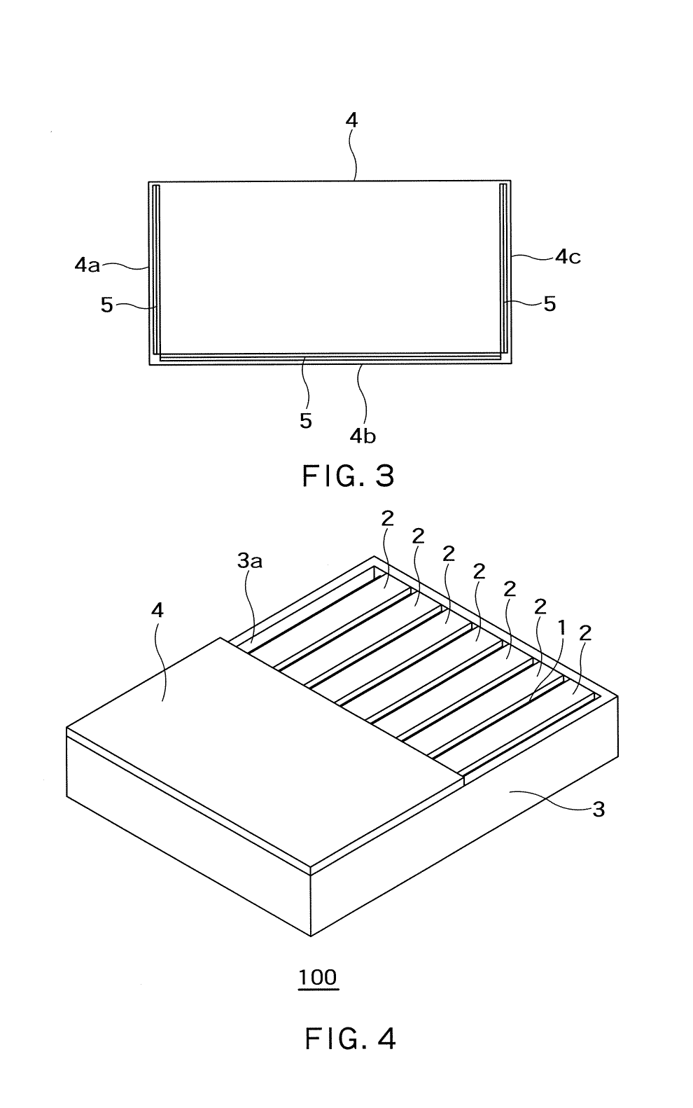

FIG. 3 is a bottom view showing a configuration of a mask plate of the semiconductor memory card according to the embodiment 1 of the present invention, which is an aspect of the present invention.

A mask plate 4 is made of a resin, such as polycarbonate, similar to that of the base card 3. The mask plate 4 is mounted on the top of a side wall 3b of the base card 3 to cover the semiconductor package 1 in such a manner that at least a part of the input/output terminal 2 is exposed. As shown in FIG. 3, the mask plate 4 has connecting parts 5 made of a resin, such as polycarbonate, on outer edges 4a, 4b and 4c thereof which are to be in contact with the base card 3. Since the mask plate 4 is made of a resin, such as polycarbonate, as described above, the mask plate 4 is not damaged as a result of insertion to the socket for the card, unlike the conventional paper label. In this embodiment and the other embodiments, for example, the connecting parts 5 are fusion parts 5.

The fusion parts 5 formed along the outer edges 4a, 4b and 4c have the shape of a rib having a triangular cross section, for example. Thus, the fusion parts 5 can be heated to the melting point of the resin in a short time and effectively welded to the base card 3 by applying concentrated ultrasonic vibrations to the fusion parts 5.

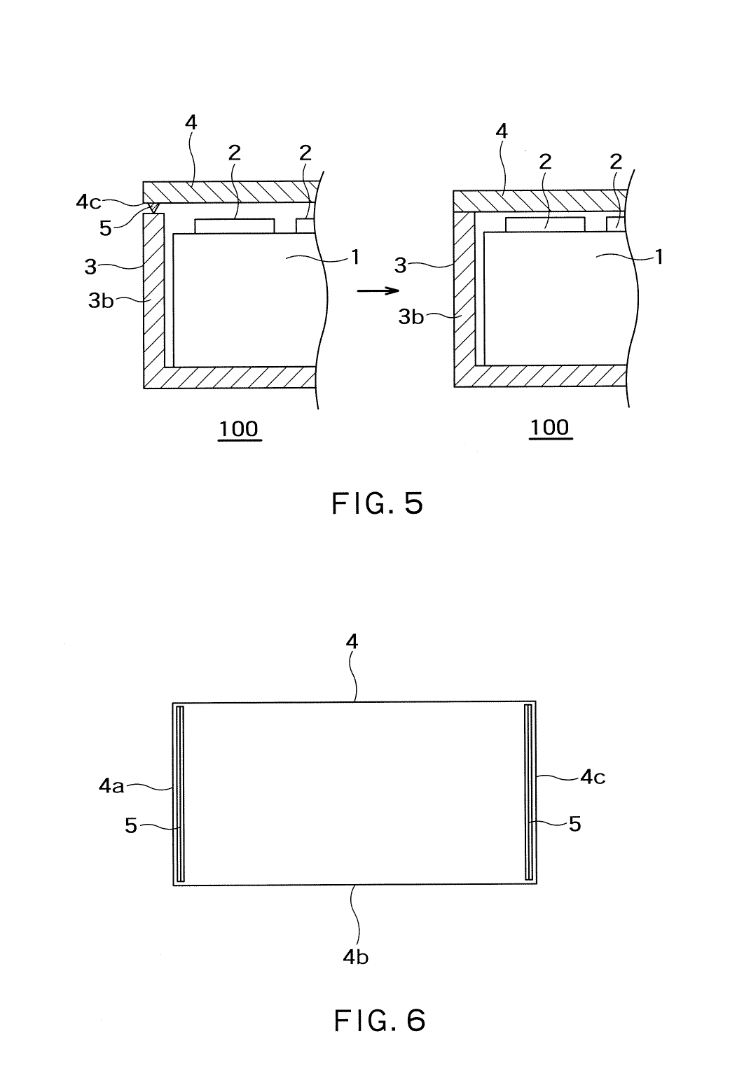

Now, the semiconductor memory card having the components described above will be described. FIG. 4 is a diagram showing a configuration of the semiconductor memory card according to the embodiment 1 of the present invention, which is an aspect of the present invention. FIG. 5 is a cross-sectional view showing a configuration of the semiconductor memory card according to the embodiment 1 of the present invention, which is an aspect of the present invention.

As shown in FIG. 4, a semiconductor memory card 100 has the base card 3, the semiconductor package 1 mounted in the base card 3 in such a manner that the input/output terminal 2 is exposed through the opening 3a, and the mask plate 4 mounted on the top of the side wall 3b of the base card 3 and covers the semiconductor package 1 in such a manner that at least a part of the input/output terminal 2 is exposed.

As shown in FIG. 5, the base card 3 and the mask plate 4 are ultrasonic-welded by making the fusion parts 5 molten by applying ultrasonic vibrations.

Since the fusion parts 5 have the shape of a rib having a triangular cross section as described above, the fusion parts 5 can be heated to the melting point of the resin in a short time and effectively welded to the base card 3 by applying concentrated ultrasonic vibrations to the fusion parts.

Since the base card 3 and the mask plate 4 are welded to each other, the bonding strength between the base card 3 and the mask plate 4 is high, and damage to the mask plate 4 serving as a label can be effectively prevented, compared with a case where the conventional adhesive label is applied to the semiconductor package.

Similarly, in a case where the product name, code or the like is marked by laser on the mask plate 4 made of resin, a break of the mask plate at the site of the mark can be effectively prevented compared with the case where the conventional technique is used.

Now, other examples of the fusion parts of the mask plate will be described.

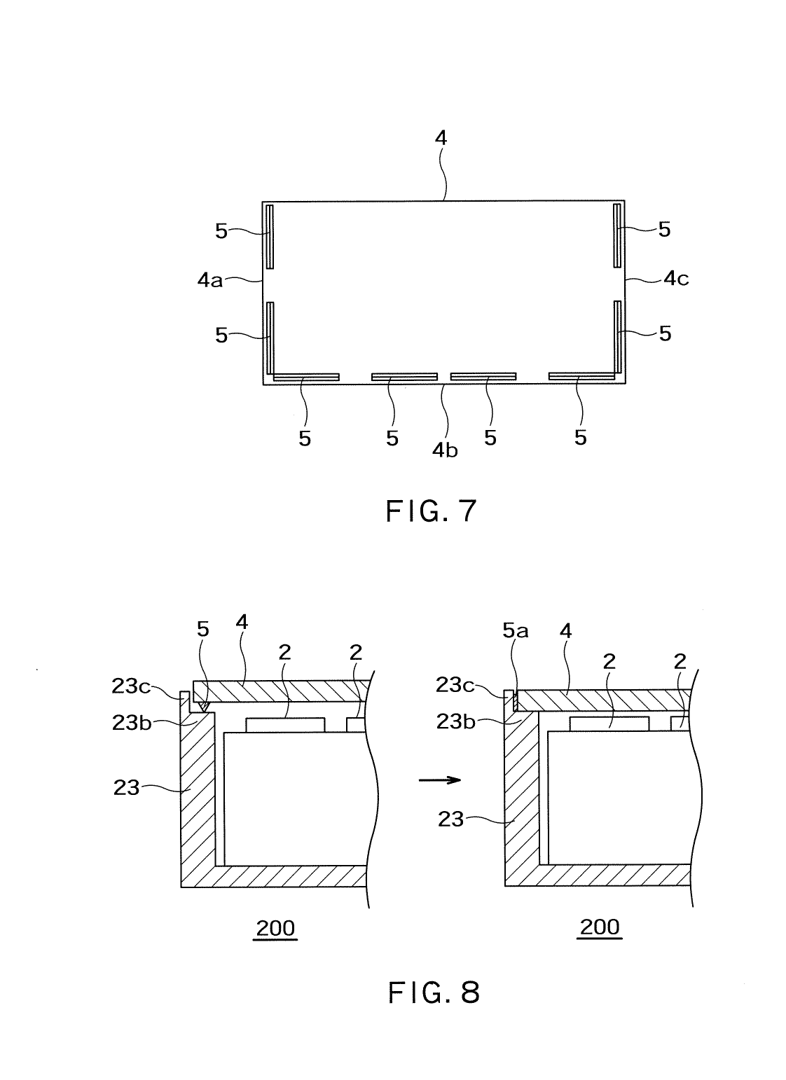

FIGS. 6 and 7 are diagrams showing other configurations of the mask plate of the semiconductor memory card according to the embodiment 1 of the present invention, which is an aspect of the present invention.

In the example described above, the fusion parts 5 of the mask plate 4 are formed along the outer edges 4a, 4b and 4c.

However, as shown in FIG. 6, the fusion parts 5 may be formed only along the outer edges 4a and 4c.

Alternatively, as shown in FIG. 7, each of the fusion parts 5 may be divided into sections spaced apart at desired intervals.

In this case, the volume of the resin molten by application of ultrasonic vibrations can be reduced, so that burrs can be prevented from being formed as a result of welding.

However, as described above, according to the conventional technique described above, application of the label (mask material) may be inappropriate at the edge between the base card and the semiconductor package because of the height difference therebetween, and the label may come off the base card in the edge area thereof. Furthermore, the label (mask material) may peel off or be broken after repeated insertions of the semiconductor memory card to the socket. Furthermore, if the product name, code or the like is marked on the label by laser, the label may be broken at the site of the mark.

Thus, in the conventional technique, there is a problem that, if the label (mask material) peels off or is broken, the semiconductor package may come off the base card, or an unwanted signal may be input to the input/output terminal and cause malfunction of the semiconductor memory card, thereby reducing the reliability, for example.

On the other hand, as for the semiconductor memory card according to this embodiment, the mask plate (mask material) serving as a label can be prevented from peeling off or being broken, the semiconductor package can be prevented from coming off the base card, and the reliability can be improved.

### Embodiment 2

In the embodiment 1 described above, the base card and the mask plate are ultrasonic-welded to each other by making the fusion parts molten by applying ultrasonic vibrations. However, in an embodiment 2 described below, the fusion parts that are molten as a result of ultrasonic welding are prevented from flowing to the outside and forming burrs.

FIG. 8 is a diagram showing a configuration of a semiconductor memory card 200 according to the embodiment 2 of the present invention, which is an aspect of the present invention. In this drawing, the same reference numerals as those in the embodiment 1 denote the same components as those in the embodiment 1.

As shown in FIG. 8, a base card 23, which is made of a resin, such as polycarbonate, has a ridge 23c that is formed on the top of a side wall 23b around the periphery of the area to be welded to a mask plate 4. The ridge 23c serves as a dam and prevents the fusion parts that are molten as a result of ultrasonic welding from flowing to the outside and forming burrs.

As shown in FIG. 8, the base card 23 and the mask plate 4 are ultrasonic-welded by making fusion parts 5 molten by applying ultrasonic vibrations. The ridge 23c described above prevents resin 5a, which is the fusion parts 5 molten, from flowing to the outside of the semiconductor memory card 200 and forming burrs.

Thus, as for the semiconductor memory card according to this embodiment, the mask plate (mask material) serving as a label can be prevented from peeling off or being broken, and the semiconductor package can be prevented from coming off the base card as in the embodiment 1, and in addition to that, formation of burrs as a result of welding can be prevented.

### Embodiment 3

In the embodiment 2 described above, the mask plate has fusion parts. However, in an embodiment 3 described below, fusion parts are formed on the top of the side wall of the base card.

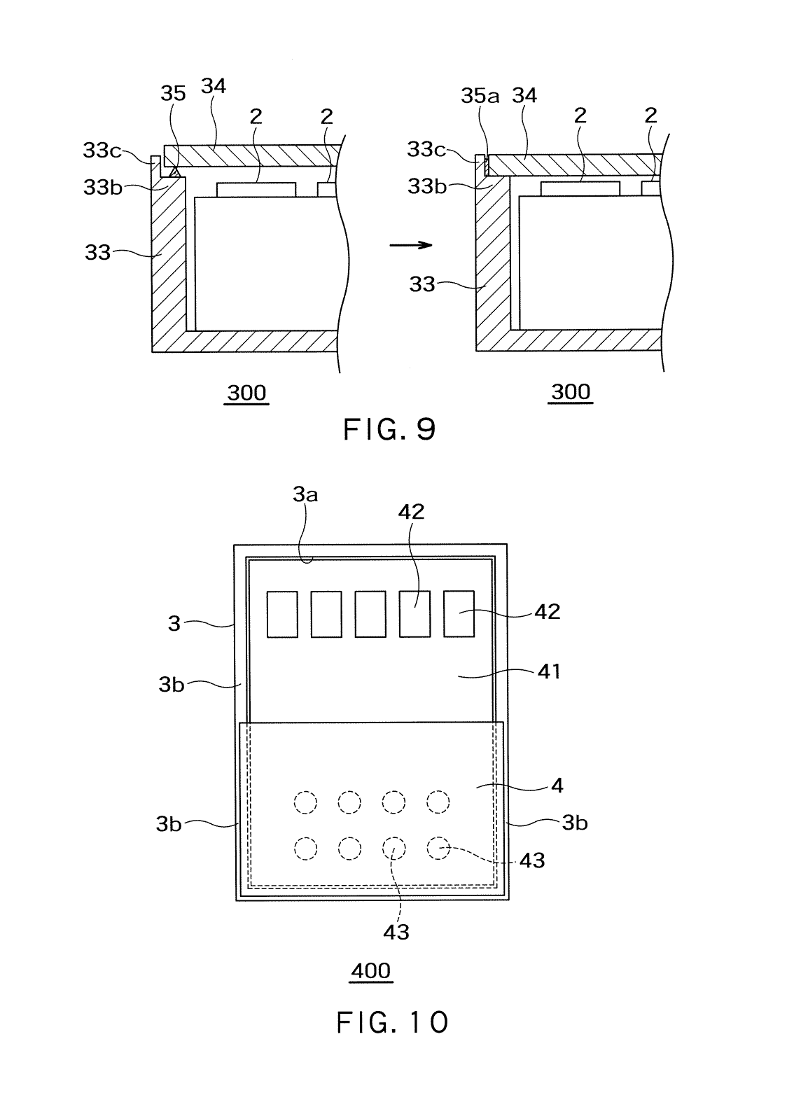

FIG. 9 is a diagram showing a configuration of a semiconductor memory card 300 according to the embodiment 3 of the present invention, which is an aspect of the present invention. In this drawing, the same reference numerals as those in the embodiment 1 denote the same components as those in the embodiment 1.

As shown in FIG. 9, a base card 33, which is made of a resin, such as polycarbonate, has a ridge 33c that is formed on the top of a side wall 33b around the periphery of the area to be welded to a mask plate 34 and fusion parts 35 made of a resin, such as polycarbonate.

The fusion parts 35 have the shape of a rib having a triangular cross section, for example, and are formed along the top surface of the side wall 33b. Thus, the fusion parts 35 can be heated to the melting point of the resin in a short time and effectively welded to the mask plate by applying concentrated ultrasonic vibrations to the fusion parts 35.

In addition, as in the embodiment 2, the ridge 33c prevents resin 35a that is molten as a result of ultrasonic welding from flowing to the outside and forming burrs.

Thus, as for the semiconductor memory card according to this embodiment, as in the embodiment 2, the mask plate (mask material) serving as a label can be prevented from peeling off or being broken, the semiconductor package can be prevented from coming off the base card, and formation of burrs as a result of welding can be prevented.

### Embodiment 4

In the embodiment 1 described above, the semiconductor package has the input/output terminal. However, in an embodiment 4 described below, an internal terminal for input and output of a desired signal from and to the outside is formed on the upper surface of the semiconductor package.

FIG. 10 is a diagram showing a configuration of a semiconductor memory card 400 according to the embodiment 4 of the present invention, which is an aspect of the present invention. In this drawing, the same reference numerals as those in the embodiment 1 denote the same components as those in the embodiment 1.

As shown in FIG. 10, a semiconductor memory card 400 has a base card 3, a semiconductor package 41 that has an internal terminal 43 formed on the upper surface thereof, which allows input and output of a desired signal between a semiconductor memory and the outside during assembly of the semiconductor memory card 400, and is mounted in the base card 3 in such a manner that the input/output terminal 42 is exposed through an opening 3a, and a mask plate 4 that is mounted on the top of a side wall 3b of the base card 3 and covers the top of the semiconductor package 41 in such a manner that the input/output terminal 42 is exposed and the internal terminal 43 is covered.

As in the embodiments 1 to 3, the base card 3 and the mask plate 4 are ultrasonic-welded to each other by making fusion parts molten by applying ultrasonic vibrations.

The internal terminal 43 is used by the manufacturer of the semiconductor memory card 400. For example, during assembly of the semiconductor memory card 400, the manufacturer writes a program or the like to the semiconductor memory in the mounted semiconductor package 41 via the internal terminal 43, and a test signal for detecting a defect in the semiconductor memory in the mounted semiconductor package 41 is input and output via the internal terminal 43. After these operations by the manufacturer are completed, the base card 3 and the mask plate 4 are welded to each other. Thus, the internal terminal 43 is insulated by the mask plate 4 from the outside. In this way, since the internal terminal unnecessary for the users is insulated from the outside, input of an unwanted signal is prevented, and malfunction or the like of the semiconductor memory card 400 is prevented.

In this embodiment also, as in the embodiments 2 and 3, a ridge may be formed on the top of the side wall 3b of the base card 3 to prevent formation of burrs as a result of welding.

As described above, as for the semiconductor memory card according to this embodiment, the mask plate can be prevented from peeling off or being broken, and the semiconductor package can be prevented from coming off the base card as in the embodiments 1 to 3, and in addition to that, input of an unwanted signal to the internal terminal can be prevented, and thus the reliability can be improved.

According to the embodiments described above, either one of the base card and the mask plate has the fusion parts. However, both the base card and the mask plate may have the fusion parts.

What is claimed is:

1. A semiconductor memory card comprising:
a base card having an opening on the top thereof;
a semiconductor package that incorporates a semiconductor memory having an input/output terminal that is formed on an upper surface thereof and that is electrically connected to the semiconductor memory and that can be connected to an external device, and being mounted in said base card in such a manner that the input/output terminal is exposed through said opening; and
a mask plate that is mounted on the top of a side wall of said base card and covers said semiconductor package in such a manner that at least a part of said input/output terminal is exposed,
wherein said base card and said mask plate are made of resin, at least one of said base card and said mask plate has a connecting part made of resin at a site where said base card and said mask plate are in contact with each other.

2. The semiconductor memory card according to claim 1, herein an internal terminal that allows input and output of a desired signal between said semiconductor memory and the outside during assembly is formed on the upper surface of said semiconductor package, and
said mask plate covers said internal terminal on the top of said semiconductor package.

3. The semiconductor memory card according to claim 1, herein said connecting part is a fusion part.

4. The semiconductor memory card according to claim 2, herein said connecting part is a fusion part.

5. The semiconductor memory card according to claim 3, herein said base card and said mask plate are welded to each other at said fusion part.

6. The semiconductor memory card according to claim 4, herein said base card and said mask plate are welded to each other at said fusion part.

7. The semiconductor memory card according to claim 5, herein a ridge is formed on the top of the side wall of said base card around the periphery of the area where said base card is welded to said mask plate.

8. The semiconductor memory card according to claim 6, herein a ridge is formed on the top of the side wall of said base card around the periphery of the area where said base card is welded to said mask plate.

9. The semiconductor memory card according to claim 3, herein fusion parts are disposed at desired intervals on at least one of said base card and said mask plate.

10. The semiconductor memory card according to claim 4, herein fusion parts are disposed at desired intervals on at least one of said base card and said mask plate.

11. The semiconductor memory card according to claim 5, herein fusion parts are disposed at desired intervals on at least one of said base card and said mask plate.

12. The semiconductor memory card according to claim 6, herein fusion parts are disposed at desired intervals on at least one of said base card and said mask plate.

13. The semiconductor memory card according to claim 1, herein said resin is polycarbonate.

14. The semiconductor memory card according to claim 2, herein said resin is polycarbonate.

15. The semiconductor memory card according to claim 3, herein said resin is polycarbonate.

16. The semiconductor memory card according to claim 4, herein said resin is polycarbonate.

17. The semiconductor memory card according to claim 5, herein said resin is polycarbonate.

18. The semiconductor memory card according to claim 6, herein said resin is polycarbonate.

19. The semiconductor memory card according to claim 3, herein said base card and said mask plate are ultrasonic-welded to each other at said fusion part.

20. The semiconductor memory card according to claim 4, herein said base card and said mask plate are ultrasonic-welded to each other at said fusion part.
